(19) United States
(12) Patent Application Publication
(10) Pub. No.: US 2026/0266650 A1
(43) Pub. Date: Sep. 10, 2026

(54) SELF-CALIBRATION OF NETWORK OF DIGITAL SCALES

(71) Applicant: INTERNATIONAL BUSINESS MACHINES CORPORATION, ARMONK, NY (US)

(72) Inventors: Renjith Ramakrishnan, Kollam (IN); Suman Patra, RARITAN, NJ (US); MADHUSUDHANAN RADHAKRISHNAN, Chennai (IN)

(21) Appl. No.: 19/070,764

(22) Filed: Mar. 5, 2025

(51) Int. Cl. G01G 23/01; G01G 23/42

(52) U.S. Cl. CPC G01G 23/01; G01G 23/42

(57) ABSTRACT

In an approach, a processor receives package measurement details of a package from a plurality of scales. A processor determines that a first scale of the plurality of scales has recorded a deviating measurement for the package. A processor recalibrates the first scale based on the determination that the first scale has recorded the deviating measurement for the package.

### BACKGROUND

The present invention relates to dimensioners, and more specifically, to calibration of dimensioning, weighing, and scanning systems (DWSs).

Logistics is the part of supply chain management that deals with the efficient forward and reverse flow of goods, services, and related information form a point of origin to a point of consumption according to the needs of customers. Logistics deals with the movements of materials or products from one facility to another. Logistics systems are complex and consist of a distributed set of interconnected facilities where packages are collected, measured, sorted, and dispatched.

DWSs are used by freight and logistics businesses to identify, weigh, and measure goods for transportation. DWSs create shipment records containing dimensions and/or other freight properties that have been captured. Scales may be deployed in the package movement and sorting channels to automatically determine the weight and dimensions of packages as they move through the channel. DWSs may be used in, for example, distribution centers, warehouses, or trucking terminal facilities.

### SUMMARY

According to an embodiment of the present invention, a computer-implemented method, computer program product, and computer system are provided. A processor receives package measurement details of a package from a plurality of scales. A processor determines that a first scale of the plurality of scales has recorded a deviating measurement for the package. A processor recalibrates the first scale based on the determination that the first scale has recorded the deviating measurement for the package.

### BRIEF DESCRIPTION OF THE DRAWINGS

FIG. 1 is a functional block diagram illustrating a computer environment, in accordance with an embodiment of the present invention.

FIG. 2 is a flowchart depicting operational steps of an audit function of a scale calibration program executing within the computer environment of FIG. 1, for auditing measurements of each package along multiple scales and using such data to identify faulty scales and determine a deviation or calibration error associated with each faulty scale, in accordance with an embodiment of the present invention.

FIG. 3 is a flowchart depicting operational steps of a reconcile function of a scale calibration program executing within the computer environment of FIG. 1, for adjusting weight measurements associated with a package based on a determination that the package was measured on one or more scales that have been determined by the audit function to be faulty, in accordance with an embodiment of the present invention.

FIG. 4 is a flowchart depicting operational steps of a calibrate function of a scale calibration program executing within the computer environment of FIG. 1, for generating a providing calibration feedback to scales that have been determined to be faulty by the audit function, in accordance with an embodiment of the present invention.

FIG. 5 is an example network of facilities that each include a scale and a screenshot depicting an example analytics engine and dashboard view, in accordance with an embodiment of the present invention.

FIG. 6 is a block diagram of components of the server executing scale calibration program, in accordance with an embodiment of the present invention.

### DETAILED DESCRIPTION

Embodiments of the present invention recognize that the accuracy of dimensioning, weighing, and scanning system (DWS) scales is critical to logistics businesses. Embodiments of the present invention recognize that inaccurate scales could result in incorrect billing causing customer disputes and revenue impacts. Embodiments of the present invention recognize that DWS scales require maintenance and calibration in order to maintain accuracy. Embodiments of the present invention recognize that, conventionally, the accuracy of DWS scales are validated manually by sending objects of known weights to be measured by the DWS scales and comparing the DWS scale results to the known weight of the respective object. Embodiments of the present invention recognize that such a manual approach, especially among large scale freight or logistics systems that employ thousands of digital scales across global facilities moving millions of packages, can be costly and inefficient.

Embodiments of the present invention describe an approach to proactively automate anomaly detection and calibration of DWS scales. Embodiments of the present invention utilize actual package measurements among multiple DWS scales to reconcile measurements by eliminating faulty scales from the network of scales and/or self-calibrate DWS scales in real time. Embodiments of the present invention utilize measurements from other scales in a network of scales, for an actual package traversing through the network of scales, to detect the inaccuracy of one or more DWS scales that are a part of the network. Embodiments of the present invention describe an approach to proactively reconcile DWS scale readings by eliminating faulty scales to avoid measurement impacts of real packages and/or allowing for the self-recalibration of faulty DWS scales on time, based on error deviation identified from accurate scales in the network. Embodiments of the present invention use a ranking system to validate the calibration of scales by comparing measurements produced by multiple scales for a particular package.

The present invention will now be described in detail with reference to the Figures.

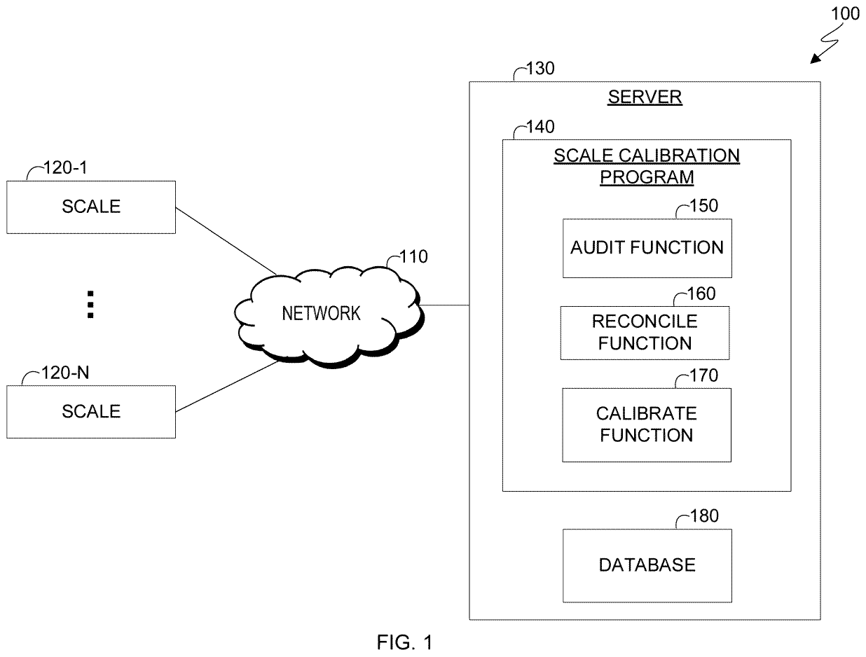

FIG. 1 is a functional block diagram illustrating a computing environment 100, in accordance with one embodiment of the present invention. FIG. 1 provides only an illustration of one embodiment and does not imply any limitations with regard to the environments in which different embodiments may be implemented.

As used herein, a reference number, such as scale 120 may refer to a single scale 120 (e.g., scale 120-1 or scale 120-N) or any number of multiple instances of the associated object (e.g., scale 120-1, scale 120-2 (not shown), and scale 120-N).

In the depicted embodiment, computing environment 100 includes scales 120 and server 130 interconnected over network 110. Network 110 may be a local area network (LAN), a wire area network (WAN) such as the Internet, the public switched telephone network (PSTN), a Bluetooth® connection, any combination thereof, or any combination of connections and protocols that will support communications between scales 120 and server 130 and, in some embodiments, other servers or computing devices (not shown), in accordance with embodiments of the invention. Network 110 may include wired, wireless, or fiber optic connections. Computing environment 100 may include additional servers, computing devices, mobile devices, or other devices not shown.

Scales 120 may each be scales that, in combination, form a network of scales 120 upon which individual packages may traverse during, for example, logistics or freight operations. In some embodiment, each scale 120 (e.g., scale 120-1, scale 120-2 (not shown), or scale 120-N) may be a digital scale of a DWS. Scales 120 may each weigh packages and be configured, along with other possible components of the DWS, to send package information and/or details to database 180. The package information and/or details may include, but is not limited to, a tracking number associated with the package, a scale identification (ID) associated with the respective scale 120 that took the weight, and package measurements (e.g., size, weight). In some embodiments, scales 120 are distributed globally and only a subset of scales 120 may be a part of any one supply chain, freight operation, or logistics operation.

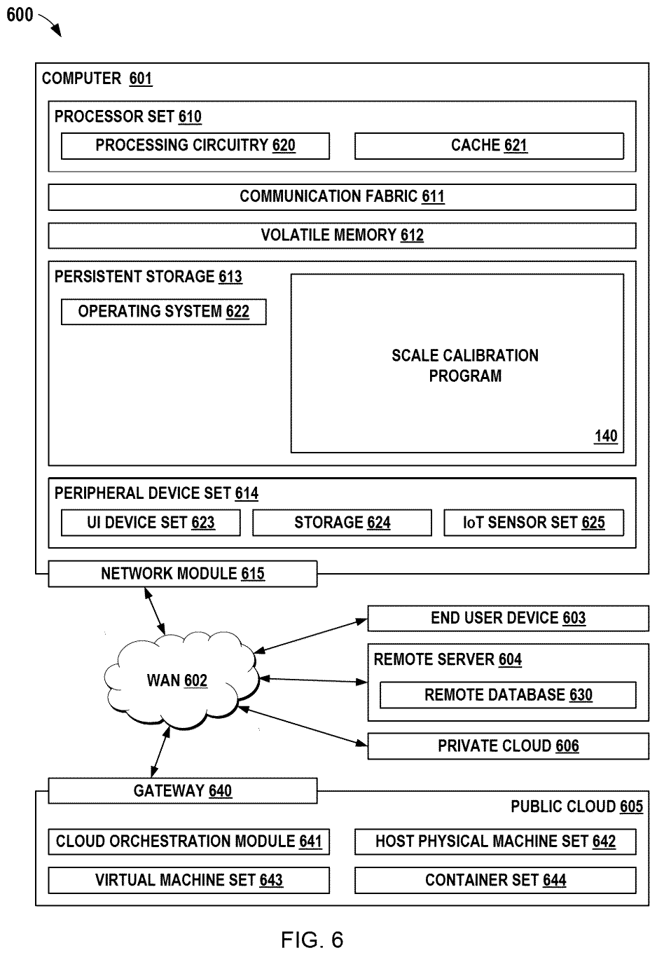

Server 130 may be a management server, a web server, or any other electronic device or computing system capable of sending and receiving data and communicating with scales 120 via, for example, network 110. In some embodiments, server 130 may represent a server computing system utilizing multiple computers as a server system, such as in a cloud computing environment. In some embodiments, server 130 contains scale calibration program 140, audit function 150, reconcile function 160, calibrate function 170, and database 180. Server 130 may include components, as depicted and described in further detail with respect to FIG. 6.

Scale calibration program 140 operates to detect anomalies in individual scales 120, adjust package weights based on detected scale 120 anomalies, and recalibrate individual scales 120 to address calibration issues such that, if possible, the scale 120 may function correctly for subsequent package measurements. In one embodiment, scale calibration program 140 resides on a server, such as server 130. In other embodiments, scale calibration program 140 may reside on another server, or another computer device, provided that scale calibration program 140 has access to database 180 and can communicate with scales 120. In the depicted embodiment, scale calibration program 140 includes audit function 150, reconcile function 160, and calibrate function 170. Scale calibration program 140 may also operate to generate and display an analytics engine and dashboard. The analytics dashboard may provide a user, such as an administrative user, with real-time visibility of scales 120 that are identified as faulty, calibration errors and impacts, and other details of such the logistics system.

Audit function 150 operates to audit measurements of each package along multiple scales 120 and to use such data to identify faulty scales 120 and determine a deviation or calibration error associated with each faulty scale 120. In some embodiments, audit function 150 is a function of scale calibration program 140 operating on server 130. In other embodiments, audit function 150 may be a separate program and is not a function of scale calibration program 140.

Reconcile function 160 operates to adjust weight measurements associated with a particular package based on a determination that the package was weighed on one or more scales 120 that have been determined by audit function 150 to be faulty. In some embodiments, reconcile function 160 operates to remove the detected measurements from any faulty scales 120 and utilize measurement values from scales that audit function 150 has determined are not faulty. In some embodiments, reconcile function 160 is a function of scale calibration program 140 operating on server 130. In other embodiments, reconcile function 160 may be a separate program and is not a function of scale calibration program 140.

Calibrate function 170 operates to generate and provide calibration feedback to scales 120 that have been determined to be faulty by audit function 150. Calibrate function 170 may operate to automatically compensate for the error deviation and, accordingly, act to recalibrate one or more faulty scales 120 such that future readings from each recalibrated scale 120 may be correct. In some embodiments, calibrate function 170 is a function of scale calibration program 140 operating on server 130. In other embodiments, calibrate function 170 may be a separate program and is not a function of scale calibration program 140.

Database 180 may be a repository that may be written to and/or read by scales 120, server 130, scale calibration program 140, audit function 150, reconcile function 160, and calibrate function 170. Database 180 may include, for example, package measurement details provided by a scale 120 (e.g., scale ID, tracking number, package measurements (e.g., size, weight)), error index and percent deviation details generated by audit function 150, target measurement updates and confidence scores generated by reconcile function 160, and/or calibration feedback data generated by calibrate function 170.

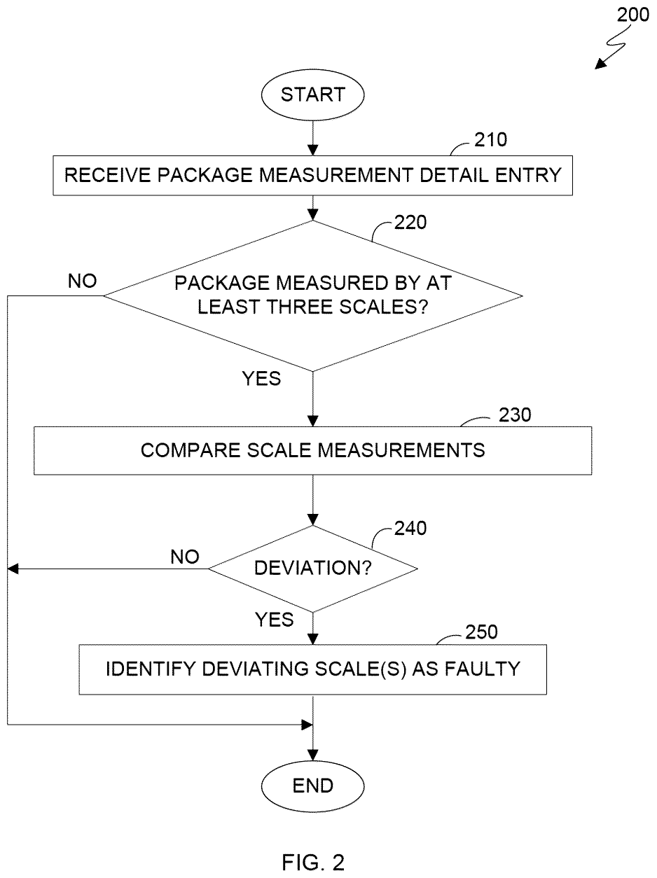

FIG. 2 depicts a flowchart 200 for the steps of audit function 150, of scale calibration program 140, executing within the computing environment 100 of FIG. 1, for auditing measurements of a package along multiple scales 120 and to use such data to identify faulty scales 120 and determine a deviation or calibration error associated with each faulty scale 120, in accordance with an embodiment of the present invention.

In one embodiment, initially, a package moves through a supply chain, freight operation, or logistics operation and traverses such that at least one scale 120 measures a weight of the package and sends the weight of the package, an identification of the package (e.g., a tracking number), and an identification of the particular scale 120 (e.g., a scale ID) to, for example, database 180. Each time a scale 120 sends such information to database 180, an entry is created and stored to database 180.

In step 210, audit function 150 receives a package measurement detail entry for a package. In some embodiments, audit function 150 monitors database 180 for any entries that audit function 150 has not yet audited. In other embodiments, upon a scale 120 storing an entry to database 180, database 180 sends the new entry to audit function 150. In particular, audit function 150 receives package measurement details that include, at least a package identifier (e.g., a tracking number), a scale identifier (e.g., a scale ID), and a measurement (e.g., weight). Audit function 150 also identifies how many different scales have measured the package via, for example, an ordinality of scan indication in the entry or by identifying how many entries include the package identifier. For example, if there are three entries that include the package identifier, and those three entries also correspond to three different scale identifiers, audit function 150 may determine that three different scales have measured the package.

In decision 220, audit function 150 determines whether the package has been measured by at least three scales. In other words, audit function 150 determines whether the package associated with the received package measurement detail entry (see step 210) had been measured by at least two other scales prior to being measured by the scale associated with the received package measurement detail entry. In some embodiments, based on an ordinality of scan indication in the entry or by identifying how many entries include the package identifier, audit function 150 is able to determine the number of scales that have measured (e.g., weighed) the package. Accordingly, audit function 150 determines whether the ordinality of scan (“N”) is greater than 2 (e.g., for the third scan, N=3).

If audit function 150 determines that fewer than three scales have measured (e.g., weighed) the package (decision 220, no branch), the function is complete. In some embodiments, audit function 150 will not calculate an error index or deviation of scales if a particular package has only been measured (e.g., weighed) twice, as embodiments of the present invention recognize that, absent a weight being known for a package in advance, it would not be possible to determine which scale was correct without corroboration between multiple scales.

If audit function 150 determines that at least three scales have measured the package, including the scale included in the present entry (decision 220, yes branch), audit function 150 compares scale measurements (e.g., weights) obtained for the package (step 230).

In step 230, audit function 150 compares the scale measurements that have been obtained for the package. For example, if the package has been weighed by three different scales, audit function 150 obtains each of the three measurements and compares the measurements to one another. In some embodiments, audit function 150 obtains each data entry associated with the package identifier and extracts both the measurement and corresponding scale identifier.

In decision 240, audit function 150 determines whether there is a deviation among the obtained measurements. In some embodiments, there is a threshold tolerance or deviation that is permissible, and the specifics of such a threshold would vary based on a variety of factors such as the corresponding industry or type of package. In some embodiments, audit function 150 determines there is a deviation if math.ceil ((N+1)/2) scales have scans that have the same value, within the specified threshold tolerance. “Math.ceil ( )” is a static method that always rounds up and returns the smallest integer greater than or equal to a given number. Audit function 150 may determine that there is no deviation if fewer than math.ceil ((N+1)/2) scales have scans that have the same value. In some embodiments, if greater than half of the scales to have measured the package return a measurement value that is within the threshold tolerance, audit function 150 determines that there is a deviation and that some scales are correct and at least one scale is faulty. Similarly, if fifty percent or fewer of the scales to have measured the package return a measurement value that matches within the threshold tolerance, audit function 150 determines that there is no recognizable deviation.

If audit function 150 determines that there is no deviation (decision 240, no branch), the function is complete. In some embodiments, audit function 150 may, upon determining that there is no deviation among any of the scales that measured the package, reset an error index and deviation of scales metric that has been previously associated with a scale. In some embodiments, audit function 150 only resets the error index and deviation of scales if each of the scales returned values within the permissible threshold tolerance.

If audit function 150 determines that there is a deviation (decision 240, yes branch), audit function identifies deviating scale(s) as faulty (step 250).

In step 250, audit function 150 identifies deviating scales as faulty. Audit function uses the results of the comparison and deviation determinations (see step 230 and decision 240) to identify which scales have returned measurements that are outside of a threshold tolerance or deviation. Audit function 150 identifies such scale(s) 120 as faulty and, in some embodiments, increments an error index (“E”) for the scale 120 identified as fault and associates the error index with the corresponding scale identifier. In some embodiments, a percentage of deviation (“D”) is also recorded. The percentage of deviation may be determined by calculating a percent difference between the measurement obtained by the correct scales 120 (e.g., scales 120 that were not identified as faulty) and the measurement obtained by the faulty scale 120. In some embodiments, audit function 150 may rest the error index and percentage deviation of the correct scales 120.

At the conclusion of an audit by audit function 150, for a faulty scale 120 (“S”), the error index (“E”) and deviation (“D) may be arrived at by the function (“AFn”) performed by audit function 150 using, for example, a tracking number (“T”), measurement (“M”), and ordinality (“N”):

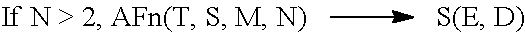

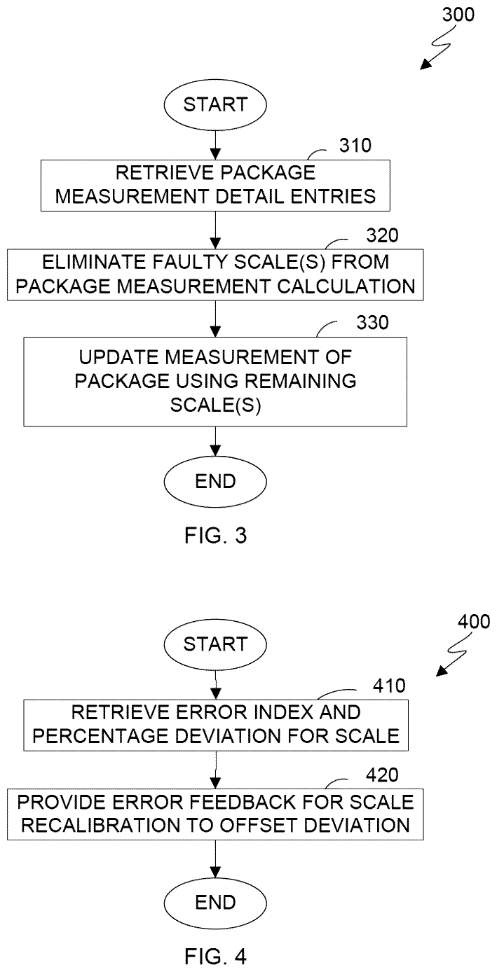

FIG. 3 depicts a flowchart 300 for the steps of reconcile function 160, of scale calibration program 140, executing within the computing environment 100 of FIG. 1, for adjusting weight measurements associated with a particular package based on a determination that the package was weighed on one or more scales 120 that have been determined by audit function 150 to be faulty, in accordance with an embodiment of the present invention.

In one embodiment, initially, a package has been measured or weighed by multiple scales 120 and audit function 150 has already determined (either previously or using the current package) that at least one scale 120 is faulty or provided an inaccurate measurement. In some embodiments, audit function 150 initializes reconcile function 160 subsequent to identifying one or more faulty scales 120 associated with a particular package. In other embodiments, reconcile function 160 initializes in response to any package being measured by one or more scales.

In step 310, reconcile function 160 retrieves the entries that include the package. In some embodiments, reconcile function 160 accesses database 180 and obtains each entry associated with the tracking number or other identification of the package. For example, if the package was measured by five different scales, database 180 may have five separate entries associated with the tracking number of the package.

In step 320, reconcile function 160 eliminates faulty scale(s) 120 from the measurement calculation for the package associated with the entries. Reconcile function 160 uses the error index and percentage of deviation of scales 120 determined to be faulty by audit function 150 and utilizes the error index and percentage of deviation metrics to adjust the calculation of measurements (e.g., weight) of the package. In some embodiments, reconcile function 160 eliminates all scales that have previously been identified as faulty by audit function 150. In other embodiments, the package may only have been measured by scales that have an error index value greater than one and, in such situations, reconcile function 160 may only eliminate scales 120 with the highest error index values or all scales 120 that are above a specified error index threshold.

In step 330, reconcile function 160 updates the measurement of the package associated with the entries using only the average of measurements obtained by the remaining scales (e.g., those scales that reconcile function 160 did not eliminate in step 320). Reconcile function 160 additionally records the updated measurement. For example, if the package was measured by five scales 120-1, 120-2, 120-3, 120-4, and 120-5, and reconcile function 160 determines that scales 120-2 and 120-4 are faulty (or, in some embodiments, do not meet an error index threshold), reconcile function 160 will update and record a target measurement (e.g., weight) associated with the package to reflect an average measurement obtained by only 120-1, 120-3, and 120-5.

In some embodiments, reconcile function 160 will additionally generate a confidence score for the updated measurement of the package. The confidence score may be based on the error index and percentage of deviation metrics obtained for each scale 120. For example, if a package has undergone only one or two scans, and if those scans were by scales 120 with a non-zero error index, the confidence score reconcile function 160 generates may be low, indicating that the package measurement has a greater chance of being incorrect than if the confidence score was higher. In generally, larger error index metrics among the scales 120 and greater percentages of deviation will lower any confidence score generated by reconcile function 160. In contrast, if a great number of scales with zero or small error index metrics obtain measurements within a permissible threshold and a small number of additional scales 120 that have been labeled as faulty have large error indexes and deviations, the confidence score may be higher. In some embodiments, reconcile function 160 may utilize weights such that scales 120 that have been more frequently accurate (e.g., zero or low error index and percentage of deviation metrics) are more heavily weighed in calculating the average (see step 330). For example, in such an embodiment, if only two scales record measurements and a first scale has a smaller error index metric than a second scale, the first scale reading may carry a larger weight in calculating the measurement for the package than the second scale.

In other words, using the findings of audit function 150 (S(E, D)), a target measurement for a particular tracking number (T(M)) can be arrived at by the function (RFn) performed by reconcile function 160:

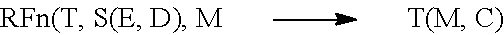

Embodiments of the present invention recognize that one advantage reconcile function 160 provides is that, even if a particular package has less than or equal to two scans, reconcile function 160 can utilize the error index and percentage of deviation metrics generated by audit function 150 from other package scans on the same scales to make a determination as to whether or not a particular scale is faulty and adjust a confidence score for the determined target measurement for the package.

FIG. 4 depicts a flowchart 400 for the steps of calibrate function 170, of scale calibration program 140, executing within the computing environment 100 of FIG. 1, for generating and providing calibration feedback to scales 120 that have been determined to be faulty by audit function 150 and to, in some instances, recalibrate the faulty scales 120, in accordance with an embodiment of the present invention.

In one embodiment, initially, audit function 150 has already generated error index and percentage of deviation metric information for at least one scale 120 (e.g., scale 120-1) in the network of scales 120.

In step 410, calibrate function 170 retrieves error index and percentage deviation information for a particular scale. The error index and percentage deviation information that calibrate function 170 retrieves may have resulted from a single package or may be a large set of data from the analysis of multiple package measurements.

In step 420, calibrate function 170 provides error feedback data to be used by the particular scale 120 to adjust calibration of the scale and offset the percentage deviation. In some embodiments, calibrate function 170 has access to a large dataset of error index and percentage deviation metrics and calibrate function 170 utilizes an average of the percentage deviation metric to determine the error feedback data. In some embodiments, rather than a percentage deviation metric, the metric specifically lists a difference in weight between the accepted correct weight of a package and the weight measured by the faulty scale 120 and, if calibrate function 170 can identify a correlation, calibrate function 170 may provide error feedback data on the basis of such a correlation. For example, if calibrate function 170 identifies that ten packages were measured by the scale and that each measurement was fifty grams higher than the correct measurement determined by reconcile function 160, calibrate function 170 may determine that the error feedback data is that the scale needs to reduce output measurements by fifty grams and such a recalibration may lead to an increased accuracy of future readings. In some embodiments, calibrate function 170 recalibrates the particular scale 120. In other embodiments, calibrate function 170 applies the error feedback to results obtained by the particular scale 120 without actually adjusting the calibration measurements obtained by the particular scale 120.

Calibrate function 170 may collect and use the output generated by audit function 150 (e.g., S(E,D)) to provide error feedback to scales 120 to compensate for calibration errors. In other words, a function (“CFn”) of calibrate function 170 may arrive at calibration feedback (“F”) for a particular scale (“S”) by:

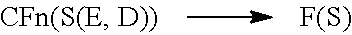

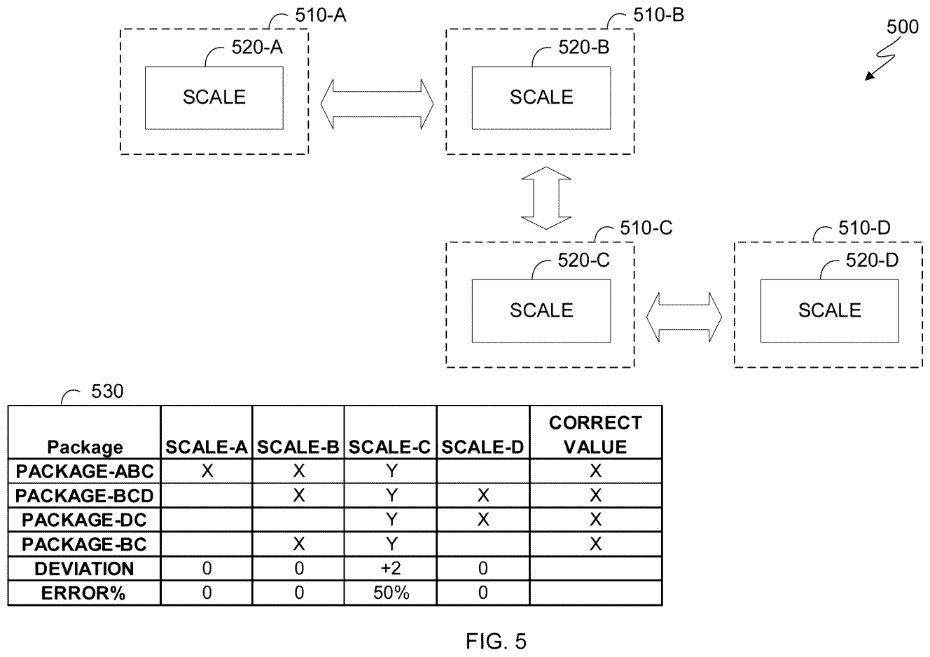

FIG. 5 depicts an example network 500 of facilities 510, each facility 510 represented as a dotted line boxed around assets included in the facility 510, along a freight or logistics operation, each facility 510 including one scale 520. FIG. 5 also includes an example screenshot 530 of one embodiment of an analytics engine and dashboard.

The depicted screenshot 530 illustrates the results of the following four package scenarios.

In a first scenario, a first package (“package ABC”) moves is measured by scales 520-A, 520-B, and 520-C as package ABS travels from facility 510-A to facility 510-C, while passing through facility 510-B on the way. As depicted in screenshot 530, scale 520-A and scale 520-B each register a first measurement X, while scale 520-C registers a second measurement of Y which deviates from the measurements of scale 520-A and 520-B.

In a second scenario, a second package (“package BCD”) moves from facility 510-B to facility 510-D through facility 510-C and is measured by scales 520-B, 520-C, and 520-D. Here, scale 520-B and scale 520-D register a first measurement X, and scale 520-C registers a second measurement of Y which deviates from the measurements of scale 520-B and 520-D. It should be noted, the X and Y measurements indicated are with respect to the particular scenario (e.g., the X measurement of the first scenario is not an identical measurement to the X measurement of the second scenario).

In a third scenario, a third package (“package DC”) moves from facility 510-D to facility 510-C and is measured by scales 520-C and 520-D. Here, scale 520-D registers a first measurement X and scale 520-C registers a second measurement Y.

In a fourth scenario, a fourth package (“package BC”) moves from facility 510-B to facility 510-C and is measured by scales 520-B and 520-C. Here, scale 520-B registers a first measurement X and scale 520-C measures a second measurement Y.

As the various functions of scale calibration program 140 operate, the screenshot 530 may be generated and, in particular, audit function 150 may be able to determine from the first and second scenarios that scale 520-C is faulty such that reconcile function 160 may update a current value for the weight of each respective package and calibrate function 170 may be able to use the metrics generated by audit function 150 to recalibrate scale 520-C.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 depicts computing environment 600 that includes, at least, a block diagram of components of server 130 of FIG. 1, in accordance with an embodiment of the present invention.

1 Computing environment 600 contains an example of an environment for the execution of at least some of the computer code involved in performing the inventive methods, such as scale calibration program 140. In addition to block 140, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 140, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 1 or FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 140 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 140 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, package measurement details of a package from a plurality of scales;
determining, by one or more processors, that a first scale of the plurality of scales has recorded a deviating measurement for the package; and
recalibrating, by one or more processors, the first scale based on the determination that the first scale has recorded the deviating measurement for the package.

2. The computer-implemented method of claim 1, further comprising:
prior to recalibrating the first scale:
calculating, by one or more processors, an average measurement for the package by removing the deviating measurement and averaging measurements obtained by remaining scales of the plurality of scales; and
recording, by one or more processors, the average measurement for the package.

3. The computer-implemented method of claim 1, wherein determining that the first scale of the plurality of scales has recorded the deviating measurement for the package comprises:
determining, by one or more processors, that the package has been measured by at least three scales;
comparing, by one or more processors, measurements obtained by each of the at least three scales; and
determining, by one or more processors, greater than fifty percent of the at least three scales have recorded matching measurements, within a threshold deviation tolerance.

4. The computer-implemented method of claim 2, further comprising:
incrementing, by one or more processors, an error index for the first scale;
calculating, by one or more processors, a percentage of deviation of the first scale based on the deviating measurement and the average measurement; and
recording, by one or more processors, the error index and the percentage of deviation.

5. The computer-implemented method of claim 4, further comprising:
generating, by one or more processors, a confidence score based on any respective error indexes and percentage of deviations recorded for the remaining scales of the plurality of scales.

6. The computer-implemented method of claim 4, wherein recalibrating the first scale comprises:
generating, by one or more processors, error feedback data to adjust calibration of the first scale using the percentage of deviation of the first scale.

7. The computer-implemented method of claim 4, further comprising:
resetting, by one or more processors, respective error indexes and percentage of deviations for the remaining scales of the plurality of scales.

8. A computer program product comprising:
one or more computer-readable storage media; and
program instructions stored on the one or more computer-readable storage media to perform operations comprising:
receiving package measurement details of a package from a plurality of scales;
determining that a first scale of the plurality of scales has recorded a deviating measurement for the package; and
recalibrating the first scale based on the determination that the first scale has recorded the deviating measurement for the package.

9. The computer program product of claim 8, wherein the operations further comprise:
prior to recalibrating the first scale:
calculating an average measurement for the package by removing the deviating measurement and averaging measurements obtained by remaining scales of the plurality of scales; and
recording the average measurement for the package.

10. The computer program product of claim 8, wherein the determining that the first scale of the plurality of scales has recorded the deviating measurement for the package comprises:
determining that the package has been measured by at least three scales;
comparing measurements obtained by each of the at least three scales; and
determining greater than fifty percent of the at least three scales have recorded matching measurements, within a threshold deviation tolerance.

11. The computer program product of claim 9, wherein the operations further comprise:
incrementing an error index for the first scale;
calculating a percentage of deviation of the first scale based on the deviating measurement and the average measurement; and
recording the error index and the percentage of deviation.

12. The computer program product of claim 11, wherein the operations further comprise:
generating a confidence score based on any respective error indexes and percentage of deviations recorded for the remaining scales of the plurality of scales.

13. The computer program product of claim 11, wherein the recalibrating the first scale comprises:
generating error feedback data to adjust calibration of the first scale using the percentage of deviation of the first scale.

14. The computer-implemented method of claim 11, wherein the operations further comprise:
resetting respective error indexes and percentage of deviations for the remaining scales of the plurality of scales.

15. A computer system comprising:
a processor set;
one or more computer-readable storage media; and
program instructions stored on the one or more computer-readable storage media to cause the processor set to perform operations comprising:
receiving package measurement details of a package from a plurality of scales;
determining that a first scale of the plurality of scales has recorded a deviating measurement for the package; and
recalibrating the first scale based on the determination that the first scale has recorded the deviating measurement for the package.

16. The computer system of claim 15, wherein the operations further comprise:
prior to recalibrating the first scale:
calculating an average measurement for the package by removing the deviating measurement and averaging measurements obtained by remaining scales of the plurality of scales; and
recording the average measurement for the package.

17. The computer system of claim 15, wherein the determining that the first scale of the plurality of scales has recorded the deviating measurement for the package comprises:
determining that the package has been measured by at least three scales;
comparing measurements obtained by each of the at least three scales; and
determining greater than fifty percent of the at least three scales have recorded matching measurements, within a threshold deviation tolerance.

18. The computer system of claim 16, wherein the operations further comprise:
incrementing an error index for the first scale;
calculating a percentage of deviation of the first scale based on the deviating measurement and the average measurement; and
recording the error index and the percentage of deviation.

19. The computer system of claim 18, wherein the operations further comprise:
generating a confidence score based on any respective error indexes and percentage of deviations recorded for the remaining scales of the plurality of scales.

20. The computer system of claim 18, wherein the recalibrating the first scale comprises:
generating error feedback data to adjust calibration of the first scale using the percentage of deviation of the first scale.
